(19) United States
(12) Patent Application Publication
(10) Pub. No.: US 2008/0223589 A1
(43) Pub. Date: Sep. 18, 2008

(54) Method and system for inducing circulation by convection in a looped fire protection system and method for installation of same

(76) Inventor: Richard Young, Edmond, OK (US)

Correspondence Address: Edward L. White, P.C., 13924-B Quail Pointe Drive, Oklahoma City, OK, 73134, US

(21) Appl. No.: 11/029,836

(22) Filed: Jan. 6, 2005

(51) Int. Cl. A62C 35/00; A62C 3/06; B05B 12/10; B05B 7/16; B05B 1/24; F04B 19/24; B05B 15/06

(52) U.S. Cl. 169/16; 169/5; 169/56; 239/75; 239/128; 239/135; 239/209; 417/207

(57) ABSTRACT

A method and system for installing and operating a multipurpose fire protection system is disclosed. The steps of the method include providing a water source to a structure, providing pre-assembled vertical sprinklers drops, installing vertical sprinkler drops at designated locations within the structure, and sequentially attaching flexible tubing to each drop to create a loop, whereby water is supplied to each sprinkler via two different flow paths. A system for simultaneously inducing flow and adding or removing heat from fluid in the piping includes a convection drop comprising a piping loop with a u-shaped section, the convection drop containing a fluid which has a density that varies as a function of temperature, and a thermal means for changing the temperature of fluid in the convection drop, whereby freezing of the fluid is prevented by adding heat using the thermal means and inducing the heated fluid to flow throughout the piping system.

### CROSS REFERENCE TO RELATED APPLICATIONS

This utility patent application follows on a related provisional patent application No. 60/534,416 filed on Jan. 5, 2004 (“Provisional Application”). That Provisional Application was, in turn, a continuation-in-part of U.S. patent application Ser. No. 10/118,207 filed on Apr. 9, 2002, which was a continuation-in-part of U.S. patent application Ser. No. 09/648,444 filed on Aug. 25, 2000, which was a continuation-in-part of U.S. Pat. No. 6,333,695, filed on May 8, 2000, which was a continuation-in-part of U.S. Pat. No. 6,239,708 filed on Jan. 18, 2000, which was a continuation-in-part of U.S. Pat. No. 6,081,196 filed on Jun. 17, 1998. Collectively, these applications will be referenced herein as “Parent Applications.”

### BACKGROUND OF THE INVENTION

1. Field of the Invention

The invention relates to the field of fire protection and suppression apparatus and methods. In particular, the invention relates to piping systems for fire protection in structures and flow elements related thereto, and still more particularly for use in multipurpose fire systems that serve both domestic and fire protection needs for water.

2. Description of the Prior Art

The National Fire Protection Association (“NFPA”) has established standards for the design and operation of multi-purpose residential fire sprinkler systems. The standard is known as NFPA 13D. It defines a multi-purpose piping system (“MPS”) as “[a] piping system within dwellings and manufactured homes intended to serve both domestic and fire protection needs.”

Typical commercial fire sprinkler systems utilize a water flow detector to provide an alarm means. When a flow of sufficient, minimal, volume is detected, typical commercial systems indicate an alarm condition. The only reason that water typically flows in commercial systems is activation of a sprinkler head. Therefore, in a typical commercial system an alarm means need only determine whether or not water is flowing.

In an MPS water regularly flows through the common piping. Flows occur to supply domestic needs within the structure. Whenever a sink, shower or toilet valve open, water flows in the MPS. Therefore, the alarm system used on typical commercial applications will not work for the MPS because simply taking a shower might cause a typical commercial flow detector to alarm when used with the MPS.

In light of this problem, typical residential and commercial applications have two completely different piping systems: (1) a fire sprinkler piping system, and (2) a domestic piping system. This doubles the number of pipes and fittings and the amount of plumbing work which has to be performed in a typical residential application. The same set of piping could not previously be used for both systems because the flow alarm could send false signals when domestic water was turned on. Alternatively, a residential application could use a fire detection system (i.e., smoke detector system). However, a smoke detection system does not alarm when water flows. Therefore, with a smoke detection system and no flow alarm, the fire sprinklers could run for days, causing extensive water damage, while the home owner is away on vacation and no alarm would sound. Also, smoke detection systems can be expensive.

One of the Parent Applications, U.S. Pat. No. 6,081,196, disclosed an Apparatus and Method for Multipurpose Residential Water Flow Fire Alarm. The apparatus for use as a multi-purpose residential fire suppression water flow alarm system was comprised of a supply side for delivering water under pressure; a multi-purpose piping system having a system side with common piping for delivering water from the supply side to a fire suppression side with one or more sprinkler heads and a domestic side for one or more domestic uses; a detecting means for detecting fire protection flow and for distinguishing that flow from a maximum domestic flow, the detecting means being disposed between the supply side and the system side; a drain test connection; and an alarm means. Using the teachings of U.S. Pat. No. 6,081,196, it is possible to incorporate a water flow alarm in an MPS.

Prior art systems also suffered from problems with freezing. Where lines were in locations that could reach temperatures below freezing, freezing in the pipes was a concern, which could crack or plug water flow in sprinkler heads and/or piping systems. Prior art systems addressed this problem in a number of ways, including dry pipe systems, which do not have any water in the piping until fire is sensed (resulting in a delayed response), by placing pipes in locations where they were not exposed to cold temperatures (for example, or by placing insulation wrap over piping systems to expose them to heated spaced below) and the like.

NFPA 13D illustrates methods of insulating piping in a ceiling joist to prevent freezing. All of the methods show the piping within and/or penetrating the ceiling joist with insulation blanketed over the piping. Similarly, all residential piping methods on the market show insulation “blanketed” over the piping to insulate it into the house to prevent freezing. In reality, it is too time consuming to route the piping through the joists, so it actually rests on top of the joists. In that installation (on top of the joists), the piping is potentially exposed to freezing temperatures. Even if a solid blanket of insulation is installed above the top of the joists (far from certain even where such an installation is specifically requested), there is still a strong possibility that construction workers in the attic or the homeowner (for example, storing Christmas decorations) will knock the insulation off the piping.

An option to ensure that the water in the MPS does not freeze is to circulate warm water therethrough. The Parent Applications disclose the use of a mechanical pump to circulate hot water from the water heater through the piping if the temperature in the piping drops below a pre-determined level (for example 40° F.). There are two potential problems with using a pump to circulate water from a hot water heater: (1) first, pumps are a relatively expensive and unreliable component within an overall plumbing system; and (2) the water circulated from the hot water heater may be at a temperature exceeding 155° Fahrenheit, potentially causing the fire protection sprinkler heads to activate. The Parent Applications teach the use of a “reverse-j fitting” to cool the water supplied to the sprinkler head to insure that the sprinkler head is not activated by the temperature of the hot water supplied thereto. Most sprinkler heads are set to activate at a temperature of 155° Fahrenheit. While it is not anticipated that hot water flowing through the multi-purpose piping system will exceed that temperature (most hot water heaters have a 140° Fahrenheit maximum temperature), the reverse-j fitting helps insure that, just in case the water does exceed that temperature, the fire sprinkler is not inadvertently activated by hot water passing thereto.

A thermocouple in communication with the pump controller and control wiring operates to ensure that a minimum desired temperature is maintained in the common piping. The thermocouple measures the temperature of water in the common piping. If the measured temperature drops below a pre-selected level, the pump controller initiates the action of a pump. The measured temperature may be a water temperature in the system preferably remote from the utility room where the heater is located. Alternatively, the temperature may be an air temperature or a combination of air and water temperature measurements. The pump draws water from the common piping via a pump inlet pipe. A pump outlet pipe directs water through a check valve and a return pipe so that it is recycled through the water heater. The return pipe connects to the inlet heater line to complete the circuit. Thus, water moved by the pump through the water heater is reheated to maintain a minimum temperature in the multi-purpose pipe section.

Though the Parent Applications and this application described the inventions therein with reference to a multi-purpose piping system, it should be understood that the system could be used with any flow-based system. Further, the flow detection means disclosed could be used with any flow system, not just fire protection systems. That is, the flow detection means are capable of detecting the flow of any fluid through a piping system. The piping system could carry hydrocarbons, solvents, or any other liquid or potentially even gaseous materials for that matter.

In operation the apparatus disclosed in the Parent Applications functioned as both a domestic water supply system and a flow detection and alarm system. Under normal conditions, the water flow rate through the flow detection means did not reach the fire suppression flow rates. When one or more sprinkler heads activated, the flow detection means detected the increased flow and sent an alarm to the alarm means. The alarm means enunciated a visible and/or audible alarm indicating the alarm condition. It is well known in the prior art to activate a telephone modem-based system for calling, for example, the fire department, upon detection of an alarm condition. See, e.g., Otten, U.S. Pat. No. 5,139,044. It was preferable to incorporate such a modem-based component in the present invention to notify the fire department and other emergency contacts should a fire alarm condition be detected. If one or more domestic cutoff valves were included in the apparatus, the flow detection means also sent a signal to activate the domestic cutoff valves, shutting off water to one or more domestic uses and providing more water for the fire sprinklers.

Also disclosed was a fire protection piping system having a water supply, a means for heating water, at least one fire protection sprinkler, a common piping means for receiving water from the supply, passing it through the heating means and delivering it to at least one fire protection sprinkler, and circulating means for circulating water through the common piping back to the heating means to maintain a specified minimum temperature in the common piping. By providing these elements, the danger of water freezing in the common piping is eliminated. In one embodiment, the circulation means comprises a pump controlled by a temperature measurement means for determining when the temperature of water in the piping drops below the minimum temperature specified. The controller engaging the pump which re-circulates the water in the piping through the heating means once the temperature drops below the desired level. At the same time, the recirculating of hot water through the system also eliminates the problem of stagnation. Preferably, at least one domestic uses is also supplied with hot water by the common piping, giving homeowners have the added benefit of instant hot water from a faucet or the like.

Traditional rigid pipe fire protection or MPS systems have usually been installed in the following order: (1) “horizontal” water supply piping is cut and assembled in place; then (2) “vertical piping” terminating at fire sprinklers was attached to the horizontal piping. This order of assembling systems requires precise location of water supply lines and exacting cuts of the rigid piping used (whether PVC, iron or other materials). It is becoming more common to use flexible piping/tubing in plumbing, fire protection or MPS systems. Therefore, there is a need for an assembly or installation method which minimizes the need for precision layout of piping system and takes advantages of the benefits of flexible piping/tubing.

While the prior art disclosed methods and apparatus to prevent freezing of water in MPS or fire protection piping, such methods and apparatus often required the use of mechanical devices to circulate water through a piping system. Alternatively, the prior art taught that insulation may be “tented” over piping to prevent freezing. At the other extreme of temperatures, fire sprinklers may be activated if the water inside the pipes reaches 140° F. or greater. Temperatures in, for example, the attic of a house can reach 140° F. in the summer. Therefore, the water in fire protection piping may have to be cooled to prevent false alarms caused by overheating of water in the summer. Additionally, the prior art taught that periodic circulation through fire protection piping was desirable to prevent stagnation. Elaborate apparatus were conceived to accomplish such desired periodic circulation. Therefore, there is a need for a simple, preferably non-mechanical method of inducing circulation in fire protection piping and alternatively heating or cooling the water inside such piping.

There is a tendency to allow traditional plumbers, rather than specialized fire protection installers, to install MPS piping in residences. The use of plumbers minimizes the cost to install these systems. However, plumbers are unfamiliar with fire protection systems, their design and installation. Therefore, there is the need for a simple, pre-engineered fire protection system that can be customized for a specific application. There is a need for a system that avoids freezing without the need for antifreeze, which is used in commercial non-MPS systems, but which cannot be used in an MPS because the antifreeze is poisonous. Further, there is a need for a system that avoids the requirement that insulation be tented over piping. Finally, systems for installation by plumbers or others not focused on the fire protection industry requires simplicity. To encourage homeowners to adopt a feature not found in most homes, it is desirable that the system be inexpensive to install and maintain.

### SUMMARY OF THE INVENTION

The present invention satisfies the needs identified above. The objects of the present invention include, but are not limited to the following: (1) providing a method of installing sprinkler “drops,” then linking them together with flexible piping/tubing; (2) providing pre-assembled vertical sprinkler drops; (3) providing design criteria to be used with the method of installing flexible piping tubing and pre-assembled sprinkler drops; (4) providing an apparatus and method of inducing flow in a loop of piping to either warm (to prevent freezing) or cool (to prevent false activation of fire sprinklers) the water therein as may be desirable.

The objectives of the invention are achieved without the need to cover the piping with insulation. Rather, circulation is induced by convective forces which do not require a pump. The convection principle allows both for the induction of circulation in system piping and for the simultaneous heating or cooling to prevent freezing or overheating (potentially activating the sprinkler heads) respectively. A convection drop is provided which typically descends from the attic into the occupied space of a structure (though it might conversely ascend upwardly from the floor). The convection drop descends some distance, preferably as much as eight feet, though just half that distance or even less may be sufficient for smaller structures. Water within the convection drop is heated or cooled as needed. The heating or cooling creates a differential density in the water. The heavier, cooler, water settles to the bottom or hot water rises to the top of the convection drop and draws fresh water into the other end of the convection drop. The fresh water is also heated/cooled, again rising or sinking and drawing still more water in. Thereby, the convection drop operates as a solid-state pump causing water to circulate through the system while, at the same time, heating or cooling it as desired.

The source of heating may be heat tape attached to or in contact with the convection drop. Alternatively, a thermoelectric circuit creating either heating or cooling by way of the Peltier effect may be provided. In the summer, the thermoelectric circuit can operate in a cooling mode to ensure that high temperatures in the attic do not activate sprinkler heads. In the winter, the thermoelectric circuit can operate in a heating mode to ensure that water in the loop does not freeze.

Whatever method is chosen to heat or cool the fluid in the convection drop, it will preferably be controlled by at least one thermocouple located within the space that is not temperature controlled, and preferably within a portion of such uncontrolled space as is most susceptible to temperature variations. When the temperature in the uncontrolled space exceeds pre-set parameters, heating or cooling is introduced as needed, simultaneously inducing circulation in the piping loop. Thermocouples may also be placed at one (or both) end(s) of the convection drop to ensure that the water is not heated or cooled beyond desired levels. For example, it would be undesirable to boil the liquid or to freeze it within the piping loop. Also, it would be undesirable to heat the fluid so much that it caused the sprinkler heads to activate. These undesired consequences of over-heating or cooling can be controlled with thermocouple(s) at the outlet from the convection drop.

As an additional safeguard, tubular insulation may be placed on the piping in the uncontrolled space. The insulation is physically attached to the piping and is thus unlikely to come off and expose the piping. Further, though it is an additional safeguard, even if it comes off, the circulation of the heated/cooled water through the piping should still prevent over-heating or freezing of the water therein.

A pre-manufactured vertical sprinkler drop can be provided in a form ready to attach to a ceiling joist. The pre-manufactured vertical sprinkler drop has a t-connector for attachment to the piping and a vertical drop of approximately the same length as the depth of the joist. Thus, when attached to the piping which rests on top of the joists, it extends downwardly so that it terminates in a sprinkler connector at the ceiling level in the structure below. A support hangar may also be included for attachment to the joist. The support hanger may include attachment means such as a lip for over-lapping engagement with the joist and/or nails or staples for convenience. Also included may be a closure for the creation of an attractive appearance around the sprinkler head.

There have thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention. Particularly, the invention is described with reference to “water” as the fluid in a multipurpose piping system. Any fluid could replace the water. The piping system could be any system for conveying a fluid therein. Further, though a residence may be referenced, the system could be used in any type of structure.

The purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE DRAWINGS

In the drawings:

FIG. 1 is an overhead representation of a system according to the present invention installed in a “loop system” configuration within a structure.

FIG. 2 is an overhead representation of a system according to the present invention installed in a “grid system” configuration within a structure.

FIG. 3 is an overhead representation of a system according to the present invention installed in a “loop system” configuration with several dead end lines that are insulated.

FIG. 4 is a preassembled line tee with attached drop nipple and hanger attached to a ceiling joist in a structure and penetrating the ceiling thereof.

FIG. 5 is a convection drop that provides both the passive pumping action and the heating or cooling as desired.

FIG. 6 is a side view of piping with insulation attached thereto.

FIG. 7 is a sectional view of piping with insulation attached thereto.

### DESCRIPTION OF THE PREFERRED EMBODIMENTS

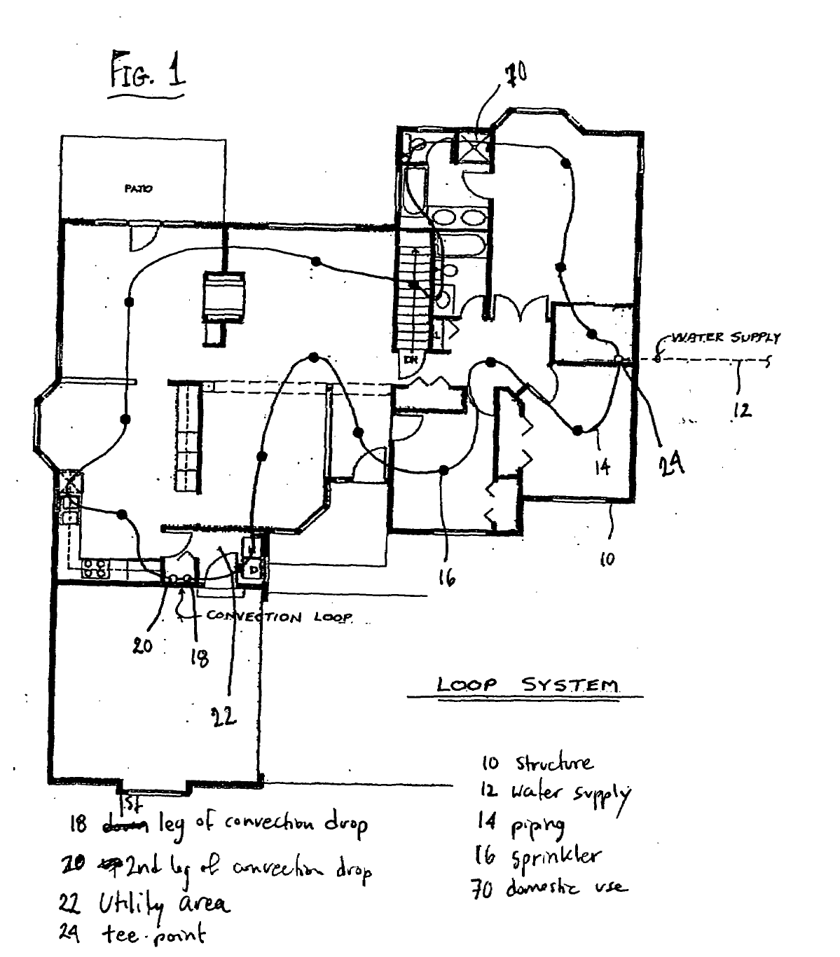

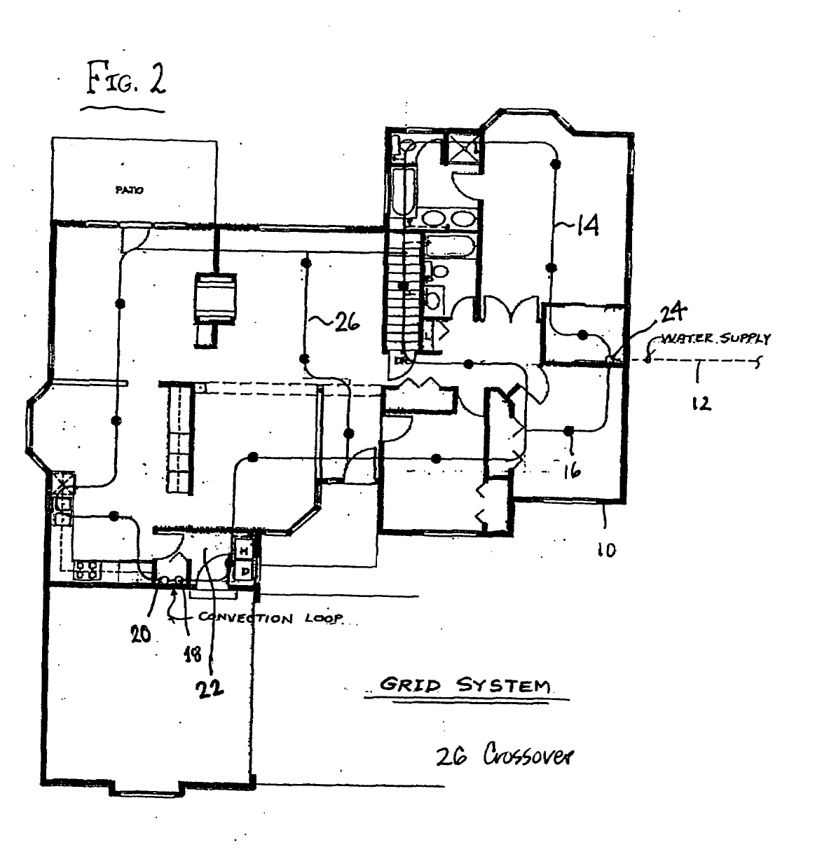

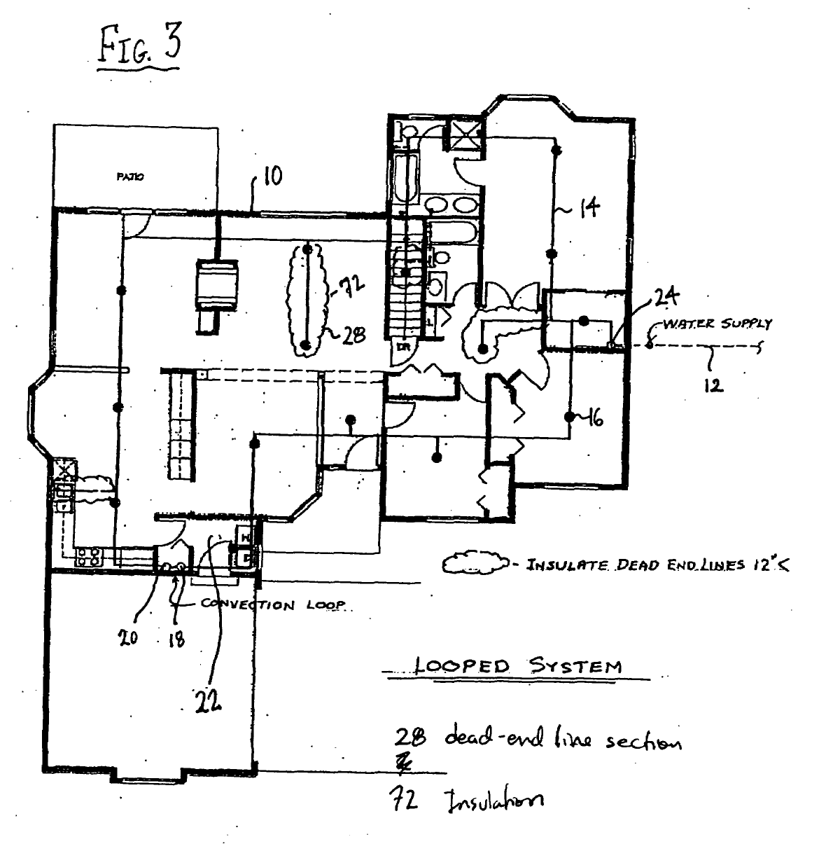

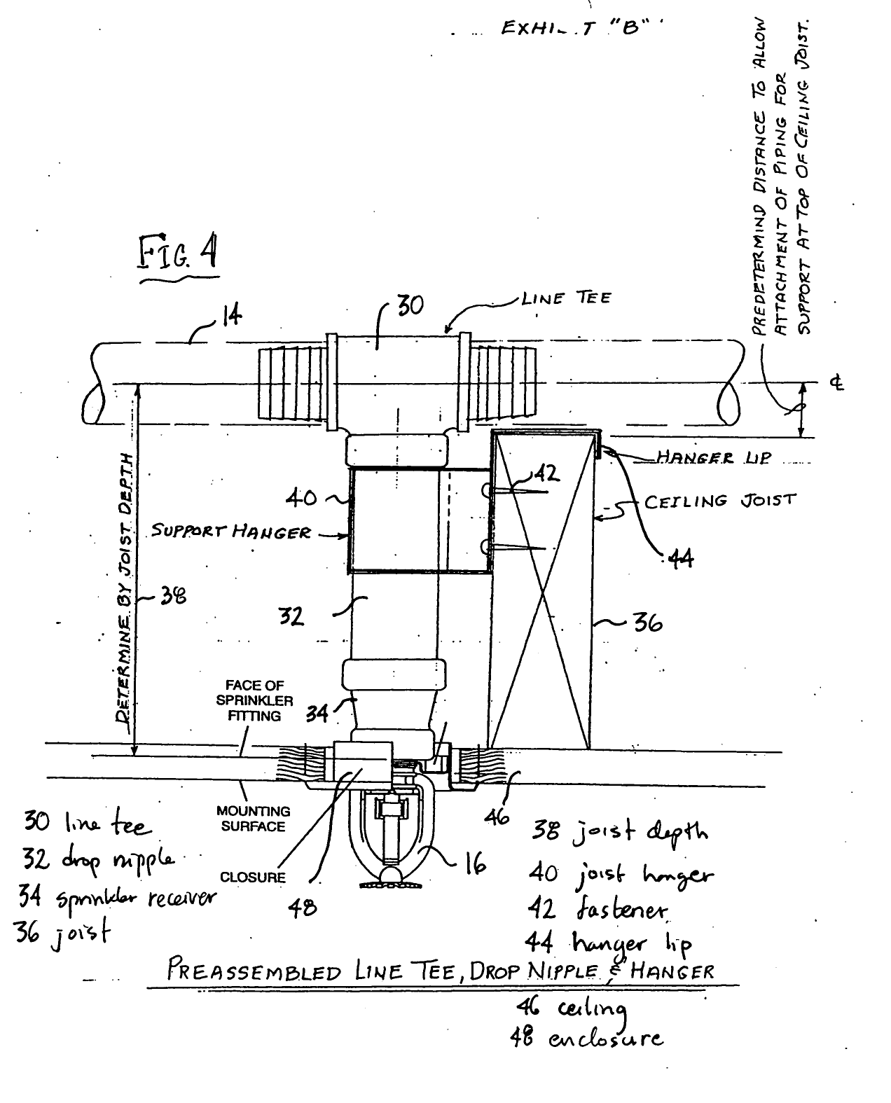

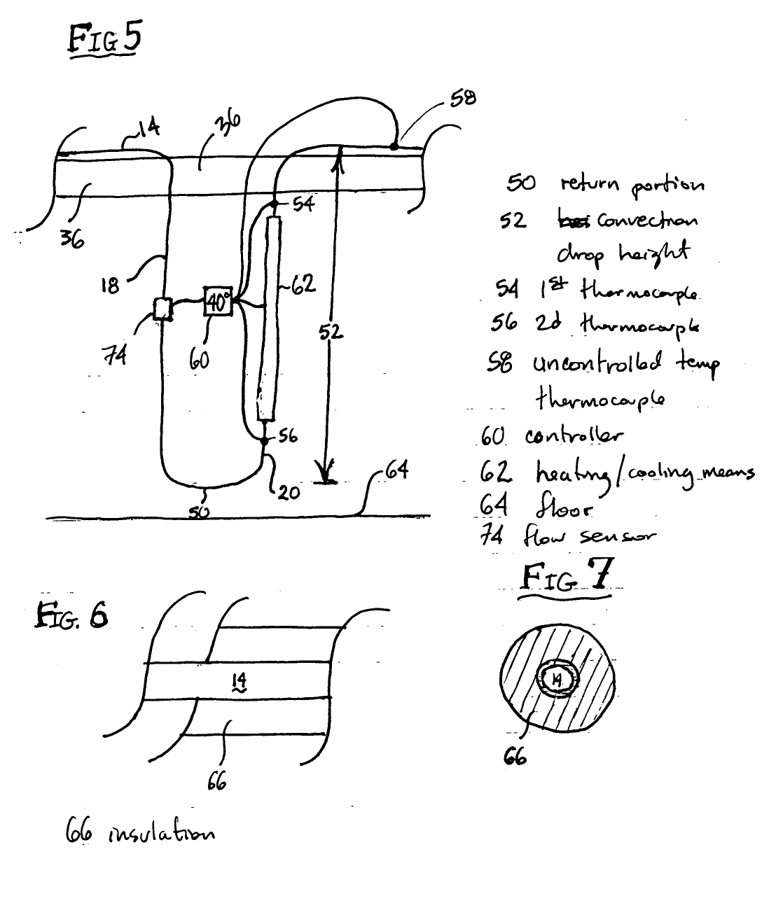

FIG. 1 shows a top plan view of a structure 10 incorporating the present invention. The structure is supplied with a water supply 12. The water supply is split at a t-point 24. From there, it flows through piping 14. Attached to the piping are multiple sprinklers 16. Also attached to the piping 14 may be multiple domestic uses 70, such as a shower, which is labeled as 70 in FIG. 1. The piping 14 leads to a first leg 18 of the convection drop 17. From there, it is connected through a return portion 50 that can be seen in FIG. 5 to a second leg 20 of the convection drop 17. The convection drop is preferably located in a utility area 22. In a residence, that could be the laundry room or garage. In the loop configuration illustrated in FIG. 1, the piping 14 is in one big loop arrangement without any dead ends or side pipes. Another example of the present invention is a grid configuration shown in FIG. 2. The only additional feature is FIG. 2, as compared to FIG. 1, is a crossover 26. The crossover 26 connects to adjoining portions of the piping 14 so that there are multiple pathways for water flowing through the system. This is good for a fire protection system as it provides maximum water flow to the sprinkler heads. However, it will provide design challenges to ensure that the crossover 26 does not short circuit flow to the other portions of the piping system. FIG. 3 illustrates another version of the loop system, but in FIG. 3 there are at least one dead end line section 28. The dead end line section 28 has to be protected with insulation 72. The insulation 72 can be tented or blown-in insulation which covers the dead end line section 28 or it can be the type of insulation 66 shown in FIGS. 6 and 7, which is adapted to closely encircle the piping 14.

FIG. 4 illustrates the preassembled line tee with drop nipple and hanger. The line tee 30 is adapted to engage the piping 14 so as to allow water to pass therethrough. A drop nipple 32 is at a substantially 90 degree angle to the line tee and the water line connected thereto. The drop nipple 32 is attached to an adjacent ceiling joist 36 by a joist hanger 40. The joist hanger is attached to the joist 36 by a fastener 42 and/or a hanger lip 44 which is adapted to overlay the ceiling joist 36. The drop nipple 32 is of a sufficient length that it can extend from the point where the piping 14 rests on top of the ceiling joist to the level of a ceiling 46 below. This distance is equal to the joist depth 38. At a terminal end of the drop nipple 32 is a sprinkler receiver 34. The sprinkler 16 is releasably engaged within the sprinkler receiver 34. Preferably the engagement is by way of pipe threads. A closure 48 may be provided so that the sprinkler 16 projecting from the ceiling 46 has an attractive appearance from below. The line tee 30, the support hanger 40, the drop nipple 32, and the sprinkler receiver 34 are preferably provided in a prepackaged format, possibly even with a fastener 42 integrally provided therewith. By providing a preformed unit, installation is facilitated, and all that an installer has to do is lay the hanger lip over the joist, attach the fasteners 42 (probably by nailing them into the joist), and move on. Later, the closure 48 can be added to improve the appearance of the sprinkler from below. The foregoing installation instructions presume that either the ceiling material (e.g., drywall) has not yet been installed or a hole has already been made in the ceiling. Otherwise, the foregoing steps would be preceded by drilling a small hole through the ceiling 46 to allow the drop nipple 32 to project there through.

FIG. 5 illustrates the heart of the connection element of present invention. Water piping 14 rests substantially on top of a ceiling joist 36. To create the convection drop 17, the water piping 14 passes downwardly into the utility portion of the structure (such as a laundry room or garage). A first leg 18 of the convection drop 17 passes down and is connected to a second leg 20 of the convection drop 17 by a return portion 50. The distance between the top of the ceiling joist 36 and the bottom of the return portion 50 is the convection drop height 52. The greater the drop height, the greater the amount of pumping action that can be accomplished by use of the convection drop 17. Three thermocouples are shown in FIG. 5. The first thermocouple 54 is at a first end of the heating/cooling means 62. A second thermocouple 56 is at a second end of the heating/cooling means 62. Another thermocouple, referred to as an uncontrolled temperature thermocouple 58, is located outside of the temperature controlled area. Preferably, the uncontrolled temperature thermocouple 58 will be in the portion of the structure's attic which is most susceptible to freezing and/or over heating. The thermocouples are in communication with the controller 60. The controller 60 may include means for entering a minimum temperature below which the heating action of the system will induce flow and introduce heat to the water in the piping 14. This selection of the minimum temperature may be by way of a temperature control panel. Alternatively, the controller could be pre-programmed with a minimum temperature such as 40 degrees Fahrenheit. In a system where the heating/cooling means 62 is also capable of cooling water within the piping 14, the controller 60 may also be programmed either manually after installation or from the factory with a maximum temperature. Above this maximum temperature, a cooling action will be induced so that the temperature of the water in the piping 14 does not exceed a level at which the sprinkler heads might be activated. As noted above, most sprinkler heads located in temperature-controlled areas are set to activate at 155 degrees Fahrenheit, so a safe temperature to ensure that level was not reached would be to set a maximum temperature of approximately 140 degrees. If cooling is desired, the heating and cooling means 62 can incorporate a thermoelectric device. Thermoelectric devices can provide both heating and cooling by simply reversing a switch. The controller 60 will activate based on a read-out from the uncontrolled temperature thermocouple 58. However, it may be that once the temperature of the uncontrolled temperature thermocouple 58 is reduced by some preset amount, it may turn off the system. For example, to prevent freezing, the controller 60 may increase the temperature of water at the uncontrolled temperature thermocouple 58 to 50 degrees Fahrenheit at which time it might shut off. Alternatively, it might run for a minimum period of time and then turn itself off. As an additional safety feature, the controller 60 may sense temperatures from both the first thermocouple 54 and the second thermocouple 56 to insure that overheating or overcooling do not occur. It is undesirable to heat water in the piping 14 to such an extent that it reaches 155 degrees Fahrenheit at which sprinklers may operate. Therefore, first thermocouple 54 and the second thermocouple 56 may be monitored to insure that overheating does not occur. Similarly, it would be undesirable to cool the water to an extent where it might freeze in the convection drop 17, so the controller 60 may monitor for that condition as well. If only heating is desired for the heating/cooling means 62, it could be by the simple way of heating tape wrapped around the second leg of the convection drop 20. The convection drop height 52 is limited by the distance between the joist and the floor 64. In most houses, that distance would be at least 8 feet, and usually 9 or 10 feet. Therefore, the convection drop height 52 will preferably be on the order of 7 to 8 feet. The longer the distance the greater the ability to pump and to inject heat or cooling into the water inside the piping 14. Alternatively, a flow sensor 74 may be provided. The flow sensor 74 insures that the operation of the convection drop is, in fact, inducing flow in the piping 14. The flow sensor 74 could be any number of well-known flow sensing elements such as a paddle switch, a sonic flow meter, or the like.

FIGS. 6 and 7 show the piping 14 insulated with insulation 66 adapted to closely engage the piping 14. This type of insulation can be used, for example, in the loop system illustrated in FIG. 3 where there are dead-end line sections 28. Alternatively, a blown-in type of insulation can be used to cover these lines and/or batted insulation could be used.

### OPERATION

The operation of various apparatus and systems utilizing the apparatus disclosed in the present invention will now be discussed.

Preferably, installers will be provided with a pre-engineered loop piping system calculations sheet which provides a fairly simple mechanism to determine the size of the piping 14 that will be required in a structure. These types of calculation sheets are available under NFPA 13(d) § 3.3.9.6. The calculation is based on maximum allowable spacing and gallons per minute flow at that spacing. The pressure of the water available in the water supply 12 at the street is put into the calculations, and the effective total pressure at the house is calculated on the size of the line flowing to the house and the distance from the water meter to the house. Based on the size of the house (its length and width), the size of the piping required can be calculated based on standard tables. Once that is done, the data can be plugged into a formula to determine the necessary characteristics of the convection drop. The volumetric flow rate through the convection loop is proportional to the convection drop height 52 multiplied times the difference in density of the fluid at the outlet versus the inlet of the convection drop times the rates of the piping to the fourth power. The full rate is inversely proportional to the length of the loop of pipe. Assuming a change in density of the water of 2% from the inlet to the outlet of the heating/cooling means 62, and a loop height of 8 feet with a diameter of the piping of half an inch (common one-inch polyethylene piping is has a ¾ inch inside diameter), and length of loop of 500 feet, which is actually longer than would be used on most applications, a total flow rate of approximately 30.5 gallons per hour can be calculated. This corresponds to an average velocity of approximately 2.5 inches per second (12.5 feet per minute) in the piping. To generate a density differential of 2%, the water has to be heated or cooled approximately 75 degrees over the typical operating range. The formula and variables used are illustrated below.

| | |
|---|---|
| | (5) |
| $Q = \frac{π {gh}_{2} ( {ρ}_{x} - {ρ}_{L} ) {R}^{4}}{8 μ L}$ | |

```
  Equation 5 provides a means to estimate the flow through the loop
based on the density differences between the fluid in region 1 and the fluid
in the rest of the piping system, region 2.
  Equation 5 can be used given the following information
```

| | | |
|---|---|---|
| g | acceleration of gravity | 32.174 ft/s² |
| h₂ | Height of loop | 8 ft |
| R | Radius of piping | 0.5 in |
| μ | Viscosity of water | 1 cp |
| L | Length of loop | 500 ft |

Given this information, if the density between region 1 and region 2 is 2% (assuming a base density of 1 gm/cm³), this density difference would generate a total flow of approximately 30.5 gal per hr. This would correspond to an average velocity in the long section of approximately 2.5 in per second.

Once the necessary calculations have been done to determine the required height of the loop and the radius of the piping, sprinklers are installed on a joist at desired locations. NFPA 13(d) specifies minimum spacing of sprinklers within a structure. Therefore, the sprinkler locations must comply with the requirements of 13(d). A hole may need to be drilled in the ceiling of a structure at the desired location. The preassembled line tee, drop nipple and hanger are then dropped over the joist resting on the hanger lip 44. The fastening means 42 can then be engaged with the joist to retain the preassembled set up in the desired location. All of the preassembled line tee, drop nipple and hanger assemblies are installed throughout the structure in desired locations. Thereafter, flexible piping 14 is installed to loop from one sprinkler location to another and also to feed any domestic uses that will take water from the system. Domestic uses that may be attached may include showers, toilets, sinks, tubs and the like. The piping needs to pass down through the utility area 22 where the convection drop will occur and it needs to include the appropriate convection drop height 52 from the foregoing calculations. Then the setup of equipment illustrated in FIG. 5 is installed in the utility area to effectuate the convection loop. Preferably, a test will be undertaken whereby the system is forced to operate, even if the temperature in the attic space is not such that it would operate normally. That is, even if the temperature in the attic is higher than 40 degrees, the system heater would be engaged to ensure that actually transfers heat and induces a flow in the MPS. The flow is checked, and the system is certified as operational.

While the invention has been shown, illustrated, described and disclosed in terms of specific embodiments or modifications, the scope of the invention should not be deemed to be limited by the precise embodiment or modification therein shown, illustrated, described or disclosed. Such other embodiments or modifications are intended to be reserved especially as they fall within the scope of the claims herein appended.

I claim:

1. a method of installing fire protection sprinklers in a structure comprising:
i. providing a water source;
ii. providing preassembled vertical sprinkler drops;
iii. installing vertical sprinkler drops at desired locations; and
iv. sequentially attaching flexible tubing to each drop to create a loop whereby, water can be supplied to any of the drops from the source via two different paths.

2. The method of claim 1 further including at least one domestic water use supplied by the flexible tubing.

3. The method of claim 1, each of the drops having a hangar support for affixing the drop to a structural member.

4. The method of claim 3, each of the drops further having a vertical length corresponding to a length of the structural member to which it is attached.

5. The method of claim 4, each of the drops further having a closure for installation at a level of a finished ceiling, whereby a finished appearance is provided when the drop is viewed from below.

6. The method of claim 5 further including at least one domestic water use supplied by the flexible tubing.

7. A system for inducing flow in a piping system comprising:
a. a piping loop including a unshaped section with a first convection drop, a return portion, and a secondary convection drop;
b. disposed within the piping loop, a fluid with a density that varies as a function of temperature; and
c. a thermal means for changing a temperature of fluid in the first convection drop, whereby, when heat or cooling is introduced into the first convection drop, the density of the fluid changes inducing a flow through the piping loop.

8. The system of claim 7 where both domestic and fire protection uses are supplied by water from the piping loop.

9. The system of claim 7 further incorporating at least one thermocouple for measuring fluid temperature and a control means for activating the thermal means when the fluid temperature reaches a set temperature.

10. The system of claim 9 where the thermal means is heat tape wrapped around the piping, whereby freezing of the fluid is prevented.

11. The system of claim 9 where the thermal means is a cooling means for removing heat from the fluid.

12. The system of claim 11 where the thermal means is a thermoelectric device for selectively removing or adding heat to the fluid.

13. The system of claim 12 where both domestic and fire protection uses are supplied by the water from the piping loop.

14. A method of designing a fire protection system for installation in a structure comprising:
a. determining the total pressure of the water supply available to the structure;
b. measuring the length and width of the structure; and
c. determining the size of tubing needed by reference to a chart showing the size of tubing needed as a function of the length plus width of the structure and the total pressure available.
